(19) United States
(12) Patent Application Publication
(10) Pub. No.: US 2006/0053925 A1
(43) Pub. Date: Mar. 16, 2006

(54) Control handle for electrohydraulic device

(75) Inventors: Didier Merletti, Saint Sorlin (FR); Xavier Roussin, La Murette (FR)

Correspondence Address: OLIFF & BERRIDGE, PLC, P.O. BOX 19928, ALEXANDRIA, VA, 22320, US

(73) Assignee: Bosch Rexroth D.S.I., Venissieux (FR)

(21) Appl. No.: 10/530,054

(22) PCT Filed: Nov. 5, 2003
(86) PCT No.: PCT/FR03/03304

§ 371 Date: Jul. 5, 2005

(30) Foreign Application Priority Data
Nov. 7, 2002 (FR) 02.13944

(51) Int. Cl. G05G 9/047

(52) U.S. Cl. 74/471 XY

(57) ABSTRACT

The invention relates to a manipulator control handle with is intended to control at least one electrohydraulic device. The inventive handle consists of: a casing defining a cavity therein; at least one set point generator comprising generator means which are used to deliver a set point signal and which are disposed in the cavity of the casing; and cursor-forming means which are disposed on the surface of the casing and which are intended to be actuated by an operator. According to the invention, the value of the set point signal delivered is related to the movement of the cursor-forming means in order to control the electrohydraulic device. The handle also comprises an electronic power board which is built into the cavity of the casing and which converts the set point signal into a power signal with a power greater than that of the set point signal, said power signal being delivered to the electrohydraulic device.

The present invention relates to a control handle for manipulator intended to control at least one electrohydraulic device.

More particularly, but not exclusively, the invention relates to control handles installed on board public works machines to control at least one of the movements of these machines.

The control handles usually encountered comprise:
a casing which delimits a cavity within it,
at least one set point generator comprising generator means to deliver a set point signal and which are situated in the cavity of the casing, and cursor-forming means which are situated on the surface of the casing and which are intended to be actuated by an operator, the value of the delivered set point signal being relative to the movement of the cursor-forming means to control the electrohydraulic device.

The set point signal delivered by the set point generator is too weak to be usable without modification in the control of the electrohydraulic device. It is therefore necessary to install an intermediate electronic stage between the control handle and the electrohydraulic device to convert the set point signal into a power signal which can control said device.

Such an intermediate electronic stage is currently directly installed in the vicinity of the electrohydraulic device, or yet located in any position, on board the machine, between the control handle usually situated in the operator's cabin and the electrohydraulic device for example installed in the vicinity of the rotating parts of the machine.

Now, electrohydraulic devices are located in positions where the stresses of temperature, humidity, spraying of oil or vibrations are high. The intermediate electronic circuit board is exposed to the same stresses such that the operation of the assembly may be affected.

Furthermore, the set point signal generated by the control handle must be transported to the location of the intermediate electronic circuit board. Since the power of the set point signal is low, this signal may be affected by the electromagnetic interference during its journey. The control of the electrohydraulic device may thus be affected.

The object of the present invention in particular is to remedy these disadvantages by providing a control handle that can be used to make the control of the electrohydraulic device more reliable using simple, effective and low cost means.

To this end, according to the invention, a control handle of the type in question is essentially noteworthy in that the handle also comprises a power electronic circuit board which is integrated into the cavity of the casing, this circuit board converting the set point signal into a power signal whose power is greater than the power of the set point signal and which is intended to be delivered to the electrohydraulic device.

Thus, thanks to these arrangements, the control handle directly delivers a power signal to the electrohydraulic device situated downstream, this power signal not being affected by the electromagnetic interference generated on board the public works machine. Furthermore, since the control handle is installed on board the operator cabin of the machine, it sustains less severe stresses.

In a preferred embodiment of the invention, the movement of the cursor-forming means of the set point generator is independent of the movement of the handle.

The movement of the cursor-forming means is advantageously linear.

As a variant, the movement of the cursor-forming means is rotary.

In a preferred manner, the value of the set point signal is proportional to the movement of the cursor-forming means.

In yet another variant, the electrohydraulic device comprises a pressure reducer.

Advantageously, the power signal delivered by the handle is of the pulse width modulation type.

As a variant, the power signal delivered by the handle is of the prescribed superposition type.

Other features and advantages of the invention will appear during the following description of one of its embodiments given as a nonlimiting example, with reference to the appended drawings, in which:

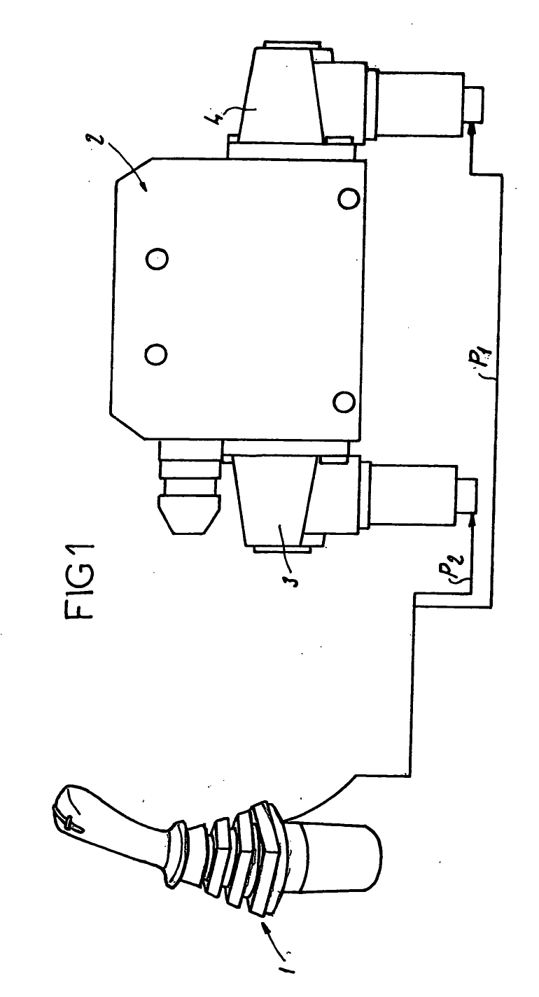

FIG. 1 is a schematic view of a control handle according to the present invention connected for example to two electrohydraulic devices.

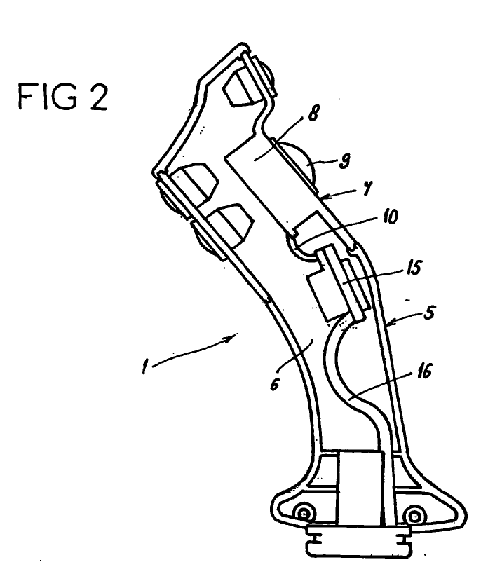

FIG. 2 is a view in longitudinal cross-section of the handle of FIG. 1 according to the present invention.

The control handle 1 shown in the figures is a handle more particularly intended to be mounted on the manipulators of public works machines. These manipulators are usually intended to control fluid distributor devices 2 known per se and which are currently encountered on board public works machines to control the movements of these machines.

The fluid distributor 2 is for example controlled by means of electrohydraulic devices 3 and 4.

The manipulators currently encountered are hydraulic but may also be electronic.

The electrohydraulic devices 3 and 4 may for example be pressure reducers controlled by a solenoid.

According to an essential feature of the present invention, these reducers each receive a power signal P_{1 and P}₂ which are directly delivered to them by the control handle 1.

As shown more particularly in FIG. 2, the control handle 1 consists in a manner known per se of a casing 5 which delimits a cavity 6 within it. This casing usually takes the form of a shell of ergonomic shape to be easily manipulated by the operator.

The control handle 1 usually comprises a set point generator 7 which has, on the one hand, generator means 8 capable of delivering a set point signal and, on the other hand, cursor-forming means 9 which are intended to be actuated by the operator of the public works machine on board which the handle is installed.

The set point generator means 8 are situated inside the shell 5, in the cavity 6, and deliver a set point signal via a cable 10. The cursor-forming means 9 are situated outside the cavity 6, on the surface of the casing 5, and are actuated by the operator to modulate the set point signal. The cursor-forming means 9 are usually moved independently of the general movement of the handle 1.

In the embodiment shown, the cursor-forming means 9 have for example a rotary movement. As a variant, these cursor-forming means may have a linear movement.

In a manner again known per se, the value of the set point signal is proportional to the movement of the cursor-forming means 9.

According to an essential feature of the present invention, the control handle 1 also comprises a power electronic circuit board 15 which converts the set point signal into a power signal P₁ or P₂ which is delivered to the electrohydraulic devices 3 and 4.

The power electronic circuit board 15 is directly installed in the cavity 6 of the casing 5, downstream of the set point generator 7 and delivers the power signal via a power cable 16 which extends from the casing 5, toward the pressure reducers 3 and 4 installed in the vicinity of the moving parts of the public works machine.

The power electronic circuit board 15 increases the power of the set point signal delivered by the set point generator 7 so that the power signal leaving the handle 1 via the power cable 16 is immediately usable to control the electrohydraulic devices situated downstream.

The control handle 1 according to the present invention is therefore used to generate a power signal which is not affected by electromagnetic interference.

Furthermore, the power electronic circuit board 15 is protected by the casing 5 of the handle 1 which is itself installed in the operator's cabin in which less stressful conditions reign.

Naturally, the invention is not limited to the example described hereinabove and various modifications may be made thereto without departing from the scope of the present invention.

1. A control handle for manipulator intended to control at least one electrohydraulic device, particularly for an item of public works machinery, comprising:
a casing which delimits a cavity within it,
at least one set point generator comprising generator means to deliver a set point signal and which are situated in the cavity of the casing, and cursor-forming means which are situated on the surface of the casing and which are intended to be actuated by an operator, the value of the delivered set point signal being relative to the movement of the cursor-forming means to control the electrohydraulic device,
characterized in that the handle also comprises a power electronic circuit board which is integrated into the cavity of the casing, this circuit board converting the set point signal into a power signal whose power is greater than the power of the set point signal and which is intended to be delivered to the electrohydraulic device.

2. The control handle as claimed in claim 1, characterized in that the movement of the cursor-forming means of the set point generator is independent of the movement of the handle.

3. The control handle as claimed in claim 1, characterized in that the movement of the cursor-forming means is linear.

4. The control handle as claimed in claim 1, characterized in that the movement of the cursor-forming means is rotary.

5. The control handle as claimed in claim 1, characterized in that the value of the set point signal is proportional to the movement of the cursor-forming means.

6. The control handle as claimed in claim 1, characterized in that the electrohydraulic device comprises a pressure reducer.

7. The control handle as claimed in claim 1, characterized in that the power signal delivered by the handle is of the pulse width modulation type.

8. The control handle as claimed in claim 1, characterized in that the power signal delivered by the handle is of the prescribed superposition type.
